(19) United States
(12) Patent Application Publication
(10) Pub. No.: US 2023/0015376 A1
(43) Pub. Date: Jan. 19, 2023

(54) Capture Control Automated Testing

(71) Applicants: Kevin Brady, Houston, TX (US); Chris Sneed, Houston, TX (US); Elias Gutierrez, Houston, TX (US)

(72) Inventors: Kevin Brady, Houston, TX (US); Chris Sneed, Houston, TX (US); Elias Gutierrez, Houston, TX (US)

(21) Appl. No.: 17/812,699

(22) Filed: Jul. 14, 2022

Related U.S. Application Data
(60) Provisional application No. 63/221,580, filed on Jul. 14, 2021.

(51) Int. Cl. G01N 3/12; G01N 3/06

(52) U.S. Cl. CPC G01N 3/12; G01N 3/06; G01N 2203/0044; G01N 2203/06

(57) ABSTRACT

The present invention relates generally to a device which is directed toward a compact, portable, lightweight and modular device for the integrity testing of equipment to determine fluid pressure, temperature and flow rates at specific locations throughout a system. The present invention provides the ability and capability to acquire data via immediate, intermediate or distanced pressure and temperature monitoring, observation and collection. Said results may be directly monitored, at an immediate, intermediate or distanced proximity, and thereby collected and digitally stored and/or transmitted, via real-time data collection and transmission, to an on-site or off-site operator or manager for remote active or passive data collection, data monitoring, data analysis and data management.

### FIELD OF THE INVENTION

The present invention relates generally to a device for digitally monitoring, testing and recording hydrostatic pressure, flow rates, pneumatic pressure and temperature via externally derived sources. Specifically, the digital monitoring, testing and recording device that is the present invention is directed toward a lightweight, portable and modular device with the ability and capability to provide immediate, intermediate or distanced pressure and temperature monitoring, observation and collection of results. Said results may be directly monitored, at an immediate, intermediate or distanced proximity, and thereby collected and digitally monitored, recorded, stored and transmitted, via real-time data transmission, to an on-site or off-site operator or manager for on-site or remote active or passive data collection and data management.

### BACKGROUND

A chart recorder historically is an electric, mechanical, magnetic or electro-mechanical device which records either electrical or mechanical input, or multiple inputs, from an external source through extrinsically supplied fluids.

The development, utilization and production of chart recorders can be traced to the use of the dynamometer, ascribed to Charles Babbage, for the measurement of railway car pulling force, carriage shake, power output of the engine, and locomotive speed.

Historically manual chart recorders have largely given way to modernized chart recorders (i.e., data loggers) consisting of embedded computer systems (i.e., a processor, memory and inputs/outputs), wherein these systems are typically integrated into a device, typically incorporating an analog-to-digital (signal) converter together with a microcontroller unit which benefit from digitalization, compact data collection and the ability to monitor, collect, store and transmit data for transmission to on-site operators, remote operators, or a combination thereof. These digital recorders are more commonly referred to as electronic ‘data loggers’ or digital data loggers (DDLs).

Electronic (digital) data loggers are designed to acquire data set to certain parameters over time. DDLs are either integrated into a device to be monitored or rely upon sensors, internal or external, which collect and relay data to an interface (i.e., an external computer) for monitoring, viewing, analyzing, recording and collecting data. The advantages of use of a digital data logger include inherent timestamping, relative immutability of data, and precision as well as access to wireless communications which may include continuous monitoring, pre-set alerts, automatic data gathering and reporting and remote access evidencing both active and passive data acquisition. In this way the current data logging system is in actuality a combination data logging system and data acquisition, monitoring, storing and transmitting system whereby data collection itself may be expanded to incorporate a breadth of data over an above the capacity of a single digital data logger.

Many infirmities exist in the area of acquiring data directly from a specific source, or plurality of sources, across an entire system whereby data monitoring and collection can be not only manually cumbersome but also may provide incomplete or easily manipulable information which further involves a high degree of risk in its procurement in areas of high temperature and high-pressure indicative of conditions across the oil and gas industry. It is therefore the object of the present invention to provide a compact, portable and lightweight modular device for the testing of pressure, temperature and flow rates at specified locations throughout a system and incorporates 256 encryption coding to prevent the manipulation of raw data. Said device has the advantages of immediate, intermediate or distanced data acquisition which may then be both transmitted to an off-site operator (via Bluetooth®, Wi-Fi®, cellular telecommunications or a combination thereof) and accessed, monitored and controlled by same said operator, additional operators or by various other control inputs.

### SUMMARY OF THE INVENTION

The present disclosure provides a novel device and method for digital hydrostatic pressure, pneumatic pressure and temperature testing, monitoring and recording via an IP 66 rated lightweight, portable, modular encasement with a capability of immediate, removed or remotely managed (and digitally transmittable) data through wired or wireless accessibility and capable of cellular telecommunications, internet connectivity or a combination thereof.

Succinctly, the present invention is used to digitally monitor pressure and temperature testing at various points within and about a fluid system while an operating technician has the option and ability to remain a safe distance away from the test subject. The unit itself is a self-contained assemblage having controls available to inspect and monitor fluid flow, pressure and temperature of a conductive media (e.g., a flowing fluid) while isolating an operator from the pressure and temperature source. The current device as well provides a means to facilitate and maintain pressure accuracy and Hz filtering capability within an exceedingly low margin of error (i.e., within 0.15% accuracy). The operator interface (i.e., pc tablet computer) ideally has a customary Windows 10 interface with wireless connectivity, along with a USB connectivity and wireless means of connectivity, allowing the operator to export data to a memory storage device, a printer, a web address, URL or email address onsite and/or remotely. The data can thereby be stored onboard, into an expandable storage drive or transmitted to a flash drive via the USB connection as well as transmitted via cellular telecommunications or through linkages to a Wi-Fi connection such as Microsoft® Teams viewer or similar viewing applications to a remote observer and/or operator. Moreover, on-site storage and transmission to off-site facilities or data storage may occur simultaneously as to leverage redundancy, allow for real-time data transmission and analysis and, further, to provide verifiability of data across several collected data points. The data file itself is presented in a proprietary format and the file size can vary depending on the length of the pressure test.

The present device exhibits an onboard pneumatic pump which is capable of pumping liquid for a hydrostatic test from 0 to 42,000 psi with Hz filtering capability. Bulkhead connections are available on the case side (or sides) and offers a quick connect providing for air and gas supply entrances and exits with additional port inlets for liquid media, when desired. The connections for the output pressure and release pressure typically are available together on the opposite side of the case and are dependent upon the pressure ranges (0-14,999 psi—NPT, 15,000-60,000 psi—HPF) although any arrangement may be configured as to best accommodate an ergonomic and efficient means to test entering and exiting fluids.

The digital chart recorder that is the present invention provides 0.15% accuracy at 30,000 Psi (2068.42 Bar) wherein each (1) psi is roughly 0.068 bar. As pressure decreases, though, accuracy increases incrementally: 25,000 Psi=0.18%, 20,000=0.23%, 15,000=0.30%, 10,000=0.45% and 5,000=rough 90%. Further, at up to 5 Hz the present invention is capable of providing operator adjustable between up to 5 readings per second to 1000 per second, accuracy (NLHR) plus or minus 0.15% of span of BFSL.

Too, the digital chart recorder that is the present invention is capable of providing the above 0.15% accuracy across multiple pressure ranges, all within a single compartmentalized data logger and data acquisition, monitoring, storing, analyzing and transmitting Windows® OS. Said system additionally defined by and encapsulated within a lightweight, durable and weatherproof (harsh environment) case.

The present invention and system utilizes a titanium wetted digital pressure transducer with temperature compensation and has been designed to measure, analyze and record pressure directly on the mobile tablet without the need for costly I/O interface boards which allows the user to measure multiple pressure & temperature inputs up 16 points simultaneously to create customized data and subsequently developed test reports with multiple templates.

Explicitly, the present invention (1) monitors, records and graphs pressure from vacuum to 72,000 PSI, (2) allows the operator to measure a plurality of pressure and temperature inputs simultaneously, (3) provides minimal setup allowing for multiple pressure and temperature ranges.

The method of use consists of the following steps:
1. Connect the high-pressure hose to the output connection located on the side of the device;
2. Extend the opposite hose end to the test subject;
3. Connect a hose to the release pressure connection;
4. Secure the opposite end at a safe location/drain;
5. Connect the air supply to the air inlet connection;
6. Connect the liquid supply to the water connection;
7. Open the “Release Pressure” valve. Energize the water supply and purge through the drain hose until all air is expelled;
8. After all air is expelled, isolate the “Release Pressure” valve;
9. The test subject can be filled prior to connecting the high-pressure hose. When connection of the high-pressure hose is made, the remaining air must be purged through a high point vent;
10. Press the on/off button to start the digital screen;
11. Software operation is exclusive to the transducer manufacturer and follows the manufacturer procedure of operation;
12. Monitor pressure via the “Output Pressure” gauge and LCD screen;
13. Established procedures must be followed for the actual pressure test; and
14. Upon completion of the test, slowly open the “Release Pressure” valve to evacuate all remaining pressure.

### BRIEF DESCRIPTION OF THE DRAWINGS

While the novel features and method of use of the application are set forth above, the application itself, as well as a preferred mode of use, and advantages thereof, will best be understood by referencing to the following detailed description when read in conjunction with the accompanying drawings in view of the appended claims, wherein:

FIG. 1 depicts an interior view of the present invention as it relates to instrumentation a combination data logging system and data acquisition, monitoring, storing and transmitting system;

FIG. 2 shows a side view of the present invention including input and output couplings;

FIG. 3 illustrates a top view of the portable, lightweight case encapsulating the present invention;

FIG. 4 is a graphical representation of liquid flow as is relates to outlet pressure;

FIG. 5 illustrates an internally centered GUI and transparent window for data observation;

FIG. 6 shows an exteriorly placed transparent window of FIG. 5.

The following legend provides numerical designations for the disclosed features of the present application:

### LEGEND

110 device
115 outer shell
120 regulated air pressure gauge
125 output pressure gauge
130 air pressure regulator
135 isolation valve
140 pressure release
145 air regulator
150 tablet graphic user interface (GUI)
155 protected USB port
160 on/off switch
210 output pressure
215 release pressure
220 suction inlet
225 air inlet
230 wheel
310 extendable handle
315 power inlet
320 retractable handle
510 centrally located GUI
520 exterior window

And, although the present invention, system and method of use are amendable to various modifications and alternative configurations, specific embodiments thereof have been offered by way of example in the figures and are herein described in adequate detail to teach those having skill in the art how to make and practice the same.

It should, however, be understood that the present disclosure and preferred embodiments provided herein, are not intended to limit the invention to one particular embodiment or embodiments, but, on the contrary, the invention disclosure is intended to cover all modifications, alternatives and equivalents falling within the spirit and scope of the invention as defined within each claim's broadest reasonable interpretation consistent with the specification.

### DETAILED DESCRIPTION OF THE INVENTION

While there are described certain embodiments, formulations and configurations constituting the present invention, and examples for illustrative purposes, it is in the contemplation of inventors to expound upon these iterations without departing from the invention's intent. And, although the following detailed description contains specific references to specific monitors and fluids, one having skill in the art will certainly appreciate that modifications, alterations and variations are within the scope of the present invention. Accordingly, the following embodiments of the invention are set forth without any loss of generality to, and without imposing limitations upon, the claimed invention. While preferred embodiments are described in connection with the description herein, there is no intent to limit the scope to the embodiments disclosed below. On the contrary, the intent is to cover all equivalents.

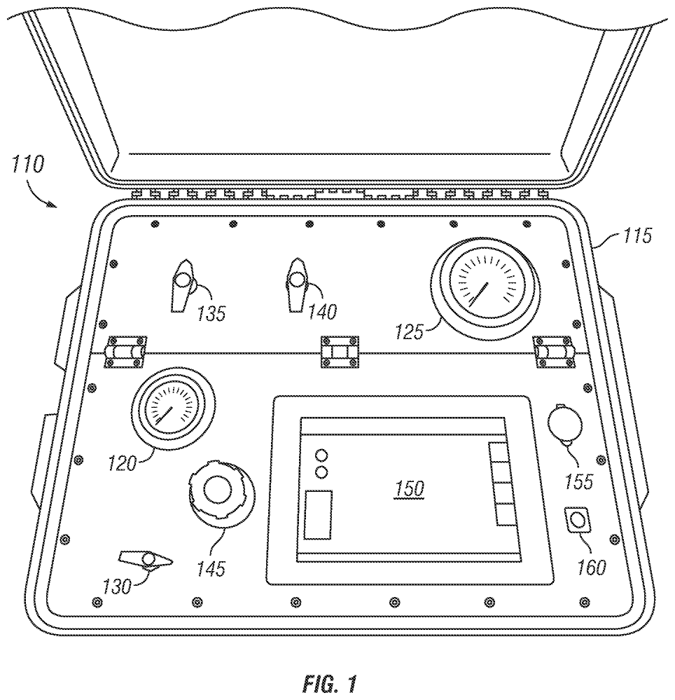

FIG. 1 is a depiction of the present invention that is digital chart recorder device 110 comprising, in various configurable and modifiable states, outer shell 115 compartmentalizing the various features of a air pressure gauge 120 for regulation of air in the system to be monitored and analyzed wherein output pressure gauge 125 measures system pressure released from the present digital chart recorder device 110, an air pressure regulator valve 130, an isolation valve 135, a pressure release 140 and air regulator 145.

Controlling the present digital chart recorder 110, in terms of a data acquisition system for collection, monitoring, recording, analyzing and conveying pressurized systems, is representative of the novel mode of replacement and removal of circular chart recorders from pressure and temperature system testing and monitoring in terms of digitization of data for improved efficiencies, enhanced accuracy, promotion of safety and obviation of unreliable data with which to make critical decisions related to pressurized systems integrity, reliability and safety.

Said increased efficiencies, reliability and safety is primarily operable through an integrated tablet computer graphic user interface (GUI) 150 incorporating a Windows® user-centric design in software application programming, providing operator/users the capability to intuitively operate said tablet computer through the direct manipulation of graphical icons, including buttons, scroll bars, windows, menus, cursors, tabs and/or a mouse pointing device to direct data logging and acquisition commands. The present invention allows for simple “start” and “stop” functionalities with quick certificate generation. In its current form a 10″ anti-glare tablet is utilized although sizes may be variable to accommodate the device's capacity and configuration.

Data may be exported via a protected USB port 155 either within the digital chart recorder 110 outer shell 115 (as shown in FIG. 1) or, conversely, externally on the exterior of the outer shell 115 (not shown). Operation is additionally controlled by on/off switch 160 aiding in ease of operability. In yet another alternative permutation, the present device may have an external keyboard and connection (not shown), with or without wired or wireless mouse, wherein a conventional keyboard may access the present tablet computer 150.

In opposite of USB data collection and storage, data may be transferred and transferrable via a wired or wireless means including wireless connectivity via Bluetooth®, Wi-Fi®, cellular telecommunications, or a combination thereof.

Power is supplied via power inlet 315 which may be of various voltages and Hz for direct power supply or as a means to charge an internal, rechargeable battery.

Multiple pressure ports (up to 16 on the present configuration) with ranges from vacuum up to 72,000 psi (most typically 60,000 psi) further including a quarter inch MPT or high-pressure bulkhead connection and thermocouple temperature reading.

In sum, the present device allows for a replacement of circular chart recorders via a digital data logger (recorder) or DCR and data acquisition system with a 0.15% accuracy in multiple pressure ranges with customizable test reports in a lightweight yet rugged mobile weatherproof case. The DCR utilizes an ESI USB digital pressure transducer and has been designed to measure, analyze and record pressure directly on the mobile tablet without the need for costly I/O interface boards. It allows the user to measure up to 16 pressure & temperature inputs simultaneously and continuously (i.e., real-time measurements) and create customized and customizable test reports in a unit weighing 10 pounds or less.

The transducer adjustable sample rate enables dynamic pressures to be measured with up to 21-bit resolution at user selectable speeds up to 1,000 Hz. For real-time analysis, data transferred to the PC is achieved without loss of accuracy or bandwidth. Data can be displayed in graphical or tabular form, with a choice of pressure units and fully adjustable scales. Data can be saved to a file or exported to Excel/PDF. The unique Silicon-on-Sapphire sensor technology provides outstanding performance and gives excellent stability over a wide temperature range. Excellent measurement accuracy provides high resolution with a precision greater than 1 in 10,000. The unit further has the following capacities and ranges:
Overpressure safety: 2× up to 6,000 PSI; 1.5× for 15,000 PSI; 1.1× for 21,500 PSI; 1.5× for 30,000 PSI; 1.25× for 60,000 PSI+
Various pressure ranges: PSI, bar, mBar, MPa, Pa, mH2O, mmHg, atm, kg/cm2, kPa
Accuracy NLHR: ≤0.15% of span BFSL
Temperature ranges: ° F. or ° C.
Operating Ambient Temperature Ranges: 32° F. to +115° F.
Storage Temperature: −4° F. to +140° F.
Temperature Effects: ±1.5% FS total error band for −14° F. to +176° F. Typical thermal zero and span coefficients ±0.015% FS/° C.
Pressure Media: All fluids compatible with Stainless Steel (¼″ NPT) or Titanium Alloy (¼″ HPF)
Wetted Parts: ¼″ NPT—Stainless Steel 316; ¼″ HPF—Titanium Alloy
Pressure Connection: ¼″ NPT or ¼″ High Pressure Female (¼″ HPF)/F250C
Optional Items: Secondary Pressure Transducer—Battery Life Extender—Pipe Mount—Upgraded Tablet Features—External Display Adapters
Dimensions: Embodiment one=16.44 in×6.82 in×13.00 in; Embodiment two=24″L×20″W×12″H

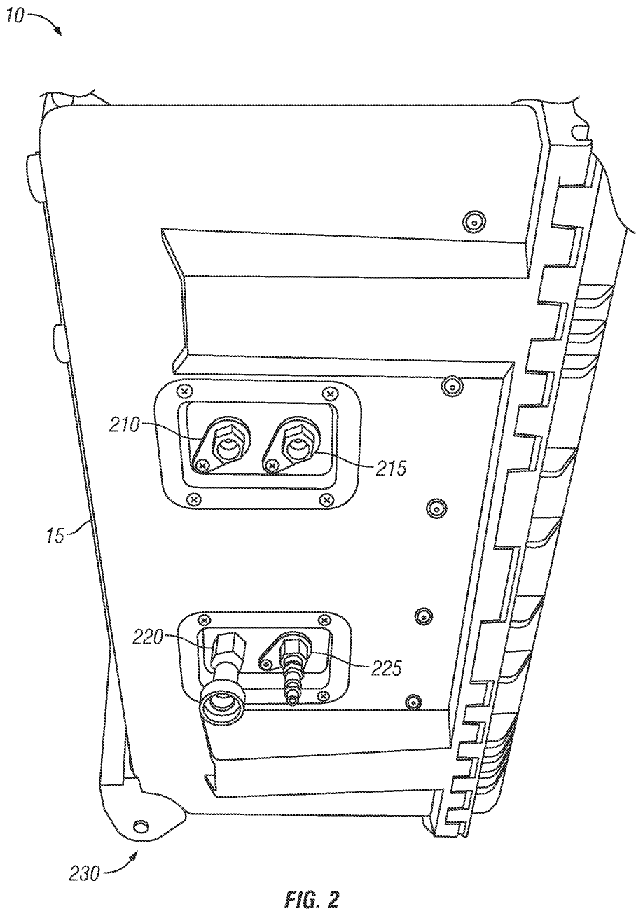

FIG. 2 is an external view of the present device 110 exhibiting on its rear panel 210 outlets: (1) output pressure 210 together with (2) release pressure 215 and inlets: (3) suction inlet 220 and air inlet 225 for coupling outputs and inputs as provided.

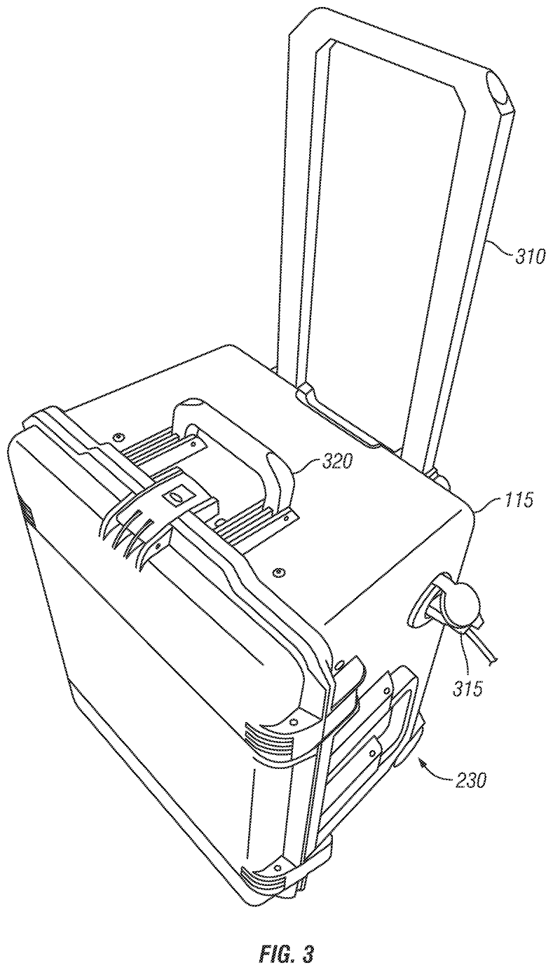

Too, the device 110, is made mobile via paired wheels 230 (see FIGS. 2 and 3) and portable through extendable handle 310 and retractable handle 320, wherein extendable handle 310 works in conjunction with wheels 230 for rolling mobility and retractable handle 320 primarily serves in carrying and lifting.

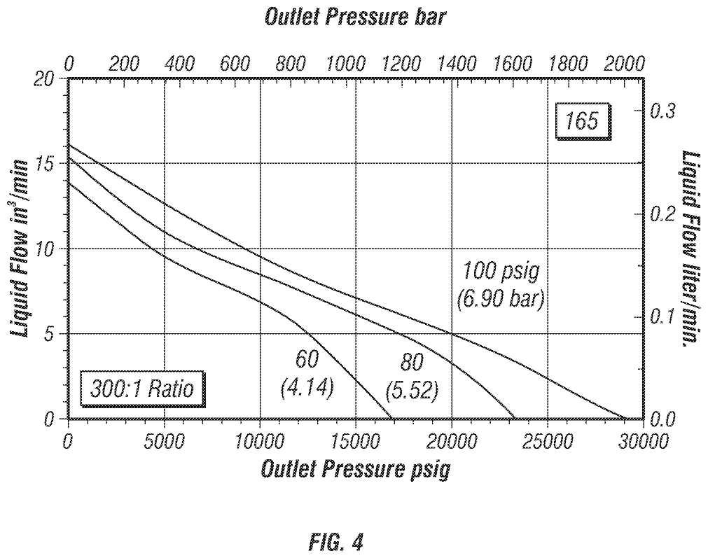

FIG. 4 denotes liquid flow on the Y axis in either in³/min (left) and L/min (right) and outlet pressure in psig (bottom) and bar (top) whereby increased flow is signified by and commensurate with increased outlet pressure with an output flow of 0.20 LPM and max output of 30,000 psi (2669 bar) and a pump ration of 300:1 and VP stroke of 0.047. When operating from 0 to rated hydraulic pressure, air consumption is approximately 14 scfm of free air at 100 psi output. At lower pressures and higher hydraulic pressures, air consumption is reduced proportionately to flow rates indicated. Of note, the present device allows for a “dry lube” pump system requiring no air line lubricator.

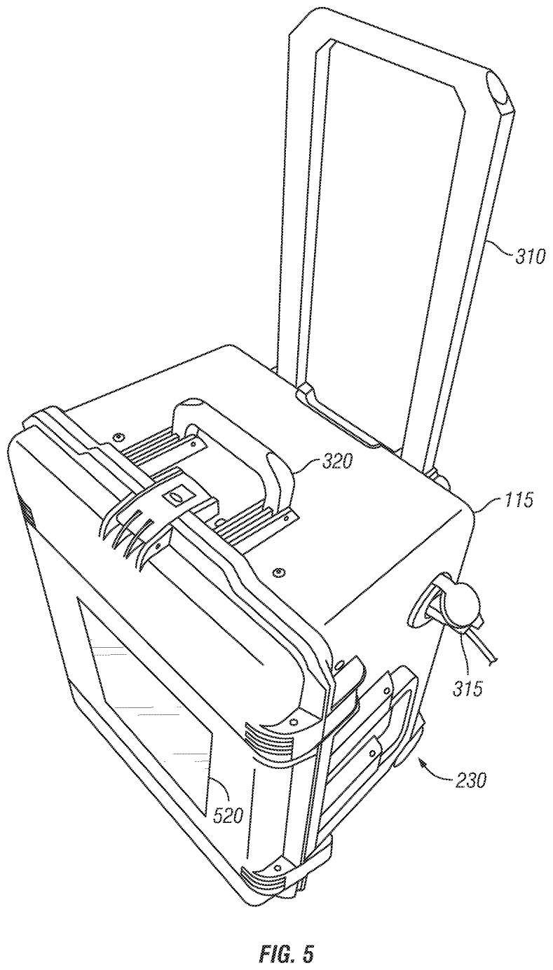

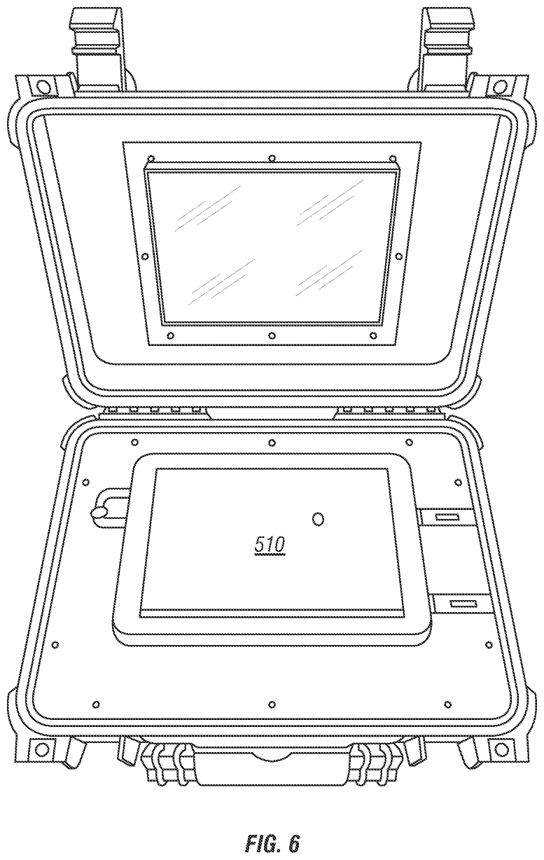

FIGS. 5 and 6 evidence an embodiment of the present device 110 whereby the tablet computer GUI is centrally located (see FIG. 6) and may be viewable via transparent external window 520 (see FIG. 5).

### PREFERRED EMBODIMENTS

In one preferred embodiment the present invention provides for a means to simplify hydrostatic/pneumatic testing, monitoring and recording of pressure, temperature and multiple other applications using a lightweight, portable, modular case with the capability to remotely manage and digitally transmit real time data.

In another embodiment, the present invention features a portable, lightweight, modular, multiple channel digital customizable monitoring/recording/reporting, stand-alone pressure supply and manifold data acquisition device which is web accessible (having 5G capability), accurate and evidence high data integrity and operator safety.

Further in another preferred embodiment, the present invention allows for pressure testing (via multiple media configurations), equipment pressure monitoring, management and testing, calibration, recording/reporting simplification all with the addition of portability and (distanced) safe use.

In yet another preferred embodiment the present system Records and graphs pressure from vacuum to 72,000 PSI provides multiple pressure ranges, allows the user to measure up to 16 pressure and temperature inputs simultaneously to create customized and customizable test reports. What is more the current configuration is easily setup, provides an ergonomic configuration and a software interface allowing for real-time pressure and temperature recording using a 10″ anti-glare touchscreen tablet mounted on the interior, horizontal surface of the present invention with an intuitive software interface for monitoring, viewing and reviewing real-time pressure & temperature data. The resultant ‘digital’ test report is shareable via USB and wireless (Bluetooth®, Wi-Fi®, telecommunications, or a combination thereof) connectivity wherein sturdy bulkhead connections are available in NPT or high-pressure designs. The unit itself is of a lightweight design (approximately 10 lbs.) with 110 V female connection for standardized “shop power” for immediate power supply or charging to an internal battery (not shown), the latter providing for untethered, autonomous operation. Yet, the current configuration may just as easily run on mains electrical supply standard US/Canadian 120V, 60 Hz (+/−% 5) or any variation thereof (e.g., Mexico 127V, 60 Hz, Chinese 220V, 50 Hz, US 240V for larger US equipment, and/or European/Russian/Australian/Qatar 240V, 50 Hz).

In yet another preferred embodiment, the present invention allows for transducer adjustable sample rates enabling dynamic pressures to be measured with up to 21-bit resolution at user/operator selectable speeds up to 1,000 Hz. For real-time analysis, data transferred to the accompanying PC is achieved without loss of accuracy or bandwidth. Data can be displayed in graphical or tabular form, with a choice of pressure units (psi, inH2O, Pascal, cgs and the like) and fully adjustable scales. Data can be saved to a file or exported to Excel/PDF. The unique Silicon-on-Sapphire sensor technology provides outstanding performance and gives excellent stability over a wide temperature range. Excellent measurement accuracy provides high resolution with a precision greater than 1 in 10,000.

In another embodiment, the operator/user may choose from an array of testing options such as leak tests, differential tests, pause/cycle tests, blind window tests, and stem tests with start/stop feature for each test permutation.

In yet another exemplary embodiment the present invention includes (1) titanium wetted silicon on sapphire sensors, (2) USB adapted sensor(s) up to 72000 psi in the pressure system, (3) vibration damped liquid free pressure gauges, (4) sample rates up to 1000 Hz in a configuration which is completely customizable with various and variable options for test and test support.

This detailed description refers to examples in the drawings and illustrations described in sufficient detail to enable those skilled in the art to practice the inventive subject matter. These examples also serve to illustrate how the inventive subject matter can be applied to numerous purposes, functions or embodiments. Other embodiments are included within the inventive subject matter, as positional, mechanical, electrical, and other changes can be made to the example embodiments described herein.

Features of various embodiments described herein, however essential to the example embodiments in which they are incorporated, do not limit the inventive subject matter as a whole. Any reference to the invention, its elements, operation, and application are not limiting, but serve only to define these example embodiments. The above detailed description does not, therefore, limit embodiments of the invention, which are defined only by the appended claims and drawings. Each of the embodiments described herein are contemplated as falling within the inventive subject matter, which is set forth in the following claims.

We claim:

1. A device for digitally collecting, monitoring, testing, recording and transmitting pressure data, flow rate data, and temperature data via close, intermediate and distanced pressure, flow and temperature data logging in combination with a data acquisition, monitoring, storing and transmitting system comprising:
titanium wetted silicon on sapphire sensors;
USB adapted sensor(s) up to 72000 psi in the pressure system;
vibration damped liquid free pressure gauges; and
sample rates up to 1000 Hz;
said sample rates occurring between up to 5 readings per second to 1000 per second.

2. A method for collecting, monitoring, testing, recording and transmitting pressure data, flow rate data, and temperature data via close, intermediate and distanced pressure, flow and temperature data logging in combination with a data acquisition, monitoring, storing and transmitting system comprising:
receiving from a data logging device pressure, flow and temperature data derived from one or more sources, one or more sensors, or a combination thereof;
collecting received pressure, flow and temperature data locally for local storage, distance storage, or a combination thereof;
coupling said source data sensor received data to a data acquisition device;
said data acquisition device capable of collecting pressure, flow and temperature data across multiple sensors and time periods;
said time periods occurring so close in time as to constitute continuous monitoring;
collecting data via said data acquisition system locally or distanced;
transmitting locally collected data via a telecommunications means to an off-site memory for collection, monitoring, analysis and storage.

3. The method of claim 2 wherein said data logging device has integrated computing device with a mobile operating system display processing circuitry (CPU)/Hardware, software, a memory, and a power source.

4. The method of claim 2 wherein operator adjustable readings between 5 readings per second to 1000 readings per second.
